(19) United States
(12) Patent Application Publication
(10) Pub. No.: US 2009/0317591 A1
(43) Pub. Date: Dec. 24, 2009

(54) Metal Composite Laminate for Producing Flexible Wiring Board and Flexible Wiring Board

(75) Inventors: Tetsuro Sato, Saitama (JP); Makoto Yamagata, Tokyo (JP); Noriaki Iwata, Tokyo (JP); Toshiaki Ono, Saitama (JP); Yasuo Komoda, Saitama (JP); Tatsuo Kataoka, Saitama (JP); Shuji Chikujo, Tokyo (JP); Naoaki Ogawa, Tokyo (JP)

Correspondence Address: THE WEBB LAW FIRM, P.C., 700 KOPPERS BUILDING, 436 SEVENTH AVENUE, PITTSBURGH, PA, 15219, US

(73) Assignee: MITSUI MINING & SMELTING CO., LTD., Tokyo (JP)

(21) Appl. No.: 12/441,110

(22) PCT Filed: Sep. 13, 2007
(86) PCT No.: PCT/JP2007/067809

§ 371 Date: Mar. 12, 2009

(30) Foreign Application Priority Data
Sep. 15, 2006 (JP) 2006-251923

(51) Int. Cl. B32B 7/00; B32B 15/08

(52) U.S. Cl. 428/141; 428/212; 428/213; 428/209

(57) ABSTRACT

A metal composite laminate for producing a flexible wiring board a wiring-forming metal layer for forming a wiring pattern that is laminated on the front surface of a flexible insulating resin layer, a support metal layer that serves as a support is laminated on the back surface of the insulating resin layer. The total thickness (Wₜ) of the metal composite laminate; the thickness (W₀) of the insulating resin layer; the mean surface roughness (Rz-1) of the wiring-forming metal layer facing the front surface of the insulating resin layer; and the mean surface roughness (Rz-2) of the support metal layer facing the back surface of the insulating resin layer are controlled.

### TECHNICAL FIELD

The present invention relates to a metal composite laminate suitable for producing a flexible wiring board excellent in heat dissipation properties, bending properties, insulation reliability and dimensional accuracy, and a wiring board having flexibility that is formed by the use of the metal composite laminate.

### BACKGROUND ART

In order to incorporate integrated circuits into electronic equipments, film carriers have been employed. The film carriers are generally formed by arranging a metal foil such as a copper foil on a surface of an insulating film base material such as a polyimide film and selectively etching the metal foil to form a wiring pattern.

However, the resin film such as a polyimide film used as the insulating film base material of the film carrier has water absorption properties, and when the resin film absorbs water in the process for producing a film carrier, the resulting film carrier tape is subject to dimensional change. Under the recent demand for film carriers of fine pitch, it is necessary to reduce an allowable dispersion of dimensional accuracy to not more than 0.01%, and therefore, it has become difficult for such a resin film as above to meet film carriers of finer pitch.

Further, such a film carrier as above is used after a solder resist layer or a coverlay layer is formed on a surface of a wiring pattern formed on the film carrier surface, and because of curing shrinkage or the like brought about when the solder resist layer or the coverlay layer is formed, warpage may take place. The insulating film base material made of the resin film, however, can hardly prevent occurrence of such warpage.

Furthermore, such a film carrier as above is often used while being bent after semiconductors are mounted thereon, and in such a case, a method in which the film carrier is used after punching of the film carrier at the bending portion is adopted. In this method, however, there is a problem that the strength at the bending portion is markedly low.

Moreover, semiconductors mounted on such a film carrier have been miniaturized and highly densified, and unless heat generated from the semiconductors is efficiently disposed of, it becomes impossible to effectively utilize high-performance semiconductors. The insulating film base material made of the resin film and used for forming the film carrier, however, has low thermal conductivity, and therefore, there is a problem that the heat generated from the semiconductors cannot be efficiently disposed of.

In order to solve such problems of the film carrier tape using the insulating film base material such as a resin film, it has been proposed to use a metal base material instead of the insulating film base material in, for example, Japanese Patent Laid-Open Publication No. 99563/1979 (patent document 1), Japanese Patent Laid-Open Publication No. 186588/1987 (patent document 2), Japanese Patent Laid-Open Publication No. 168986/1994 (patent document 3), Japanese Patent Laid-Open Publication No. 55880/1996 (patent document 4), Japanese Patent Laid-Open Publication No. 204301/1996 (patent document 5) and Japanese Patent Laid-Open Publication No. 134781/2004 (patent document 6).

In the patent documents 1 to 5, it is described to form a wiring board on a surface of a support made of a metal through an insulating layer, but such a wiring board cannot cope with bending.

In the paragraphs [0051] and [0053] of the patent document 6, it is described that a metal foil composite having a width of 600 mm, a thickness of 170 μm and a length of 250 m was prepared by continuously feeding a copper foil having a width of 600 mm and a thickness of 35 μm (surface roughness Rz: 4 μm), applying an insulating adhesive composition onto the foil so that the thickness might be 100 μm, laminating an electrodeposited copper foil having a width of 600 mm and a thickness of 35 μm whose surface to be contacted with the insulating adhesive composition had been subjected to roughening treatment (Rz: 4 μm), bonding them by a laminator under heating, curing the insulating adhesive composition by a hot air dryer, and then winding up the resulting laminate into a roll by a wind-up machine.

The metal composite described in the publication, however, has a thick layer of the insulating adhesive composition and has no flexibility, so that a wiring board that is used while being bent cannot be produced.

Patent document 1: Japanese Patent Laid-Open Publication No. 99563/1979

Patent document 2: Japanese Patent Laid-Open Publication No. 186588/1987

Patent document 3: Japanese Patent Laid-Open Publication No. 168986/1994

Patent document 4: Japanese Patent Laid-Open Publication No. 55880/1996

Patent document 5: Japanese Patent Laid-Open Publication No. 204301/1996

Patent document 6: Japanese Patent Laid-Open Publication No. 134781/2004

### DISCLOSURE OF THE INVENTION

### Problem to be Solved by the Invention

It is an object of the present invention to provide a metal composite laminate in which a support metal layer and a wiring-forming metal layer are laminated through an insulating resin layer and which is capable of forming a wiring board having high insulation reliability between the support metal layer and the wiring-forming metal layer and having flexibility.

It is another object of the invention to provide a metal composite laminate capable of forming a wiring board not only having high insulation reliability and high adhesion of metal layers to the insulating resin layer but also having excellent flexibility.

It is a further object of the invention to provide a metal composite laminate capable of forming a flexible wiring board which can efficiently remove heat generated from an IC semiconductor device.

It is a further object of the invention to provide a wiring board having high insulation reliability between a wiring pattern formed on the front surface of an insulating resin layer and a support metal layer laminated on the back surface of the insulating resin layer.

It is a further object of the invention to provide a wiring board not only having high insulation reliability and high adhesion of metal layers to the insulating resin layer but also having excellent flexibility, as described above.

It is a further object of the invention to provide a flexible wiring board capable of efficiently removing heat generated from an IC semiconductor device.

It is a further object of the invention to provide a wiring board which rarely suffers troubles such as malfunctions caused by heat generated from a high-performance IC semiconductor device even if the high-performance IC semiconductor device is mounted with high density.

### Means to Solve the Problem

The metal composite laminate for producing a flexible wiring board of the present invention is a metal composite laminate for producing a flexible wiring board, having a wiring-forming metal layer which is a layer for forming a wiring pattern and is laminated on the front surface of a flexible insulating resin layer and a support metal layer which serves as a support and is laminated on the back surface of the insulating resin layer, wherein:

the total thickness (Wₜ) of the metal composite laminate is in the range of 35 to 130 μm, and the thickness (W₀) of the insulating resin layer is in the range of 10 to 30 μm,

the mean surface roughness (Rz-1) of the wiring-forming metal layer facing the front surface of the insulating resin layer is in the range of 0.5 to 6.0 μm, preferably 0.5 to 3.0 μm, and the mean surface roughness (Rz-2) of the support metal layer facing the back surface of the insulating resin layer is in the range of 0.5 to 3.0 μm, the total [(Rz-1)+(Rz-2)] of the mean surface roughness (Rz-1) of the wiring-forming metal layer and the mean surface roughness (Rz-2) of the support metal layer is in the range of 3 to 60% of the thickness (W₀) of the insulating resin layer, and

the ratio [(Rz-2):(Rz-1)] of the mean surface roughness (Rz-2) of the support metal layer to the mean surface roughness (Rz-1) of the wiring-forming metal layer is in the range of 4:1 to 1:12, preferably 2:1 to 1:12.

The flexible wiring board of the present invention is a flexible wiring board comprising a metal composite laminate having a wiring-forming metal layer laminated on the front surface of a flexible insulating resin layer and a support metal layer laminated on the back surface of the insulating resin layer, said wiring-forming metal layer having been etched into a desired pattern, wherein:

the total thickness (Wₜ) of the metal composite laminate is in the range of 35 to 130 μm, and the thickness (W₀) of the insulating resin layer is in the range of 10 to 30 μm,

the mean surface roughness (Rz-1) of a side of the wiring pattern present on the front surface of the insulating resin layer, said side of the wiring pattern being in contact with the insulating resin layer, is in the range of 0.5 to 6.0 μm, preferably 0.5 to 3.0 μm, and the mean surface roughness (Rz-2) of a side of the support metal layer facing the back surface of the insulating resin layer, said side of the support metal layer being in contact with the insulating resin layer, is in the range of 0.5 to 3.0 μm,

the total [(Rz-1)+(Rz-2)] of the mean surface roughness (Rz-1) of the wiring pattern and the mean surface roughness (Rz-2) of the support metal layer is in the range of 3 to 60% of the thickness (W₀) of the insulating resin layer, and

the ratio [(Rz-2):(Rz-1)] of the mean surface roughness (Rz-2) of the support metal layer to the mean surface roughness (Rz-1) of the wiring pattern is in the range of 4:1 to 1:12, preferably 2:1 to 1:12.

### EFFECT OF THE INVENTION

In the metal composite laminate for producing a flexible wiring board of the invention, a metal layer having a given mean surface roughness is formed on each of the front surface and the back surface of an insulating resin layer, the insulating resin layer and each metal layer are bonded with high strength, and the ratio of the surface roughness of the metal layer to the thickness of the insulating resin layer is in the given range. Therefore, short circuit will not occur between the metal layer present on the front surface of the insulating resin layer and the metal layer present on the back surface thereof, and besides, the insulating resin layer will not hinder thermal conduction. In the wiring board formed by use of the metal composite laminate, therefore, the wiring pattern will not be peeled from the insulating resin layer even if the wiring board is bent. Moreover, heat generated on the wiring pattern side is favorably transmitted to the metal layer present on the back surface side of the insulating resin layer through the insulating resin layer, and therefore, heat generated from a semiconductor mounted on the wiring board can be efficiently removed from the metal layer arranged on the back surface side.

In the present invention, further, the mean surface roughness of the adhesive surface of the support metal layer and the mean surface roughness of the adhesive surface of the wiring-forming metal layer are those distributed according to the stress applied to the support metal layer and the stress applied to the wiring pattern formed from the wiring-forming metal layer. That is to say, the wiring board formed in this manner has excellent flexibility, and the mean surface roughness of the support metal layer and the mean surface roughness of the wiring-forming metal layer are those distributed in advance so that adhesive strength corresponding to the stress given to the bending portion may be exhibited even if the wiring board is used while being bent. On this account, in the wiring board of the invention, the wiring pattern and the support metal layer will not be peeled from the insulating resin layer even if the wiring board is used in various ways such as a way in which the wiring board is used while being bent.

### BRIEF DESCRIPTION OF THE DRAWINGS

FIG. 1 is a sectional view showing an example of a section of the metal composite laminate for producing a flexible wiring board of the invention.

FIG. 2 is an enlarged sectional view showing the vicinity of an insulating resin layer of the metal composite laminate for producing a flexible wiring board of the invention.

FIG. 3 is a sectional view showing an example of a section of the flexible wiring board of the invention.

FIG. 4 is a sectional view showing an example of a section of a substrate in the process for producing the flexible wiring board of the invention.

FIG. 5 is a sectional view showing another example of the metal composite laminate for producing a flexible wiring board of the invention.

FIG. 6 is a sectional view showing an example of the metal composite laminate for producing a flexible wiring board of the invention on which a support resin layer is arranged.

FIG. 7 is an electron micrograph showing an example of a surface of an anodized aluminum foil which can be used as a support metal layer in the metal composite laminate for producing a flexible wiring board of the invention.

### DESCRIPTION OF NUMERICAL SYMBOLS

10: support metal layer
11: front surface of support metal layer
13: recessed portion
14: protruded portion
15: back surface of support metal layer
20: insulating resin layer
22: back surface of insulating resin layer
24: front surface of insulating resin layer
25: insulating adhesive resin layer
30: wiring-forming metal layer
32: front surface of wiring-forming metal layer
33: recessed portion
34: protruded portion
35: back surface of wiring-forming metal layer
45: support resin layer

### BEST MODE FOR CARRYING OUT THE INVENTION

Next, the metal composite laminate for producing a flexible wiring board of the invention and the flexible wiring board produced by use of the metal composite laminate are described in detail hereinafter with reference to the drawings.

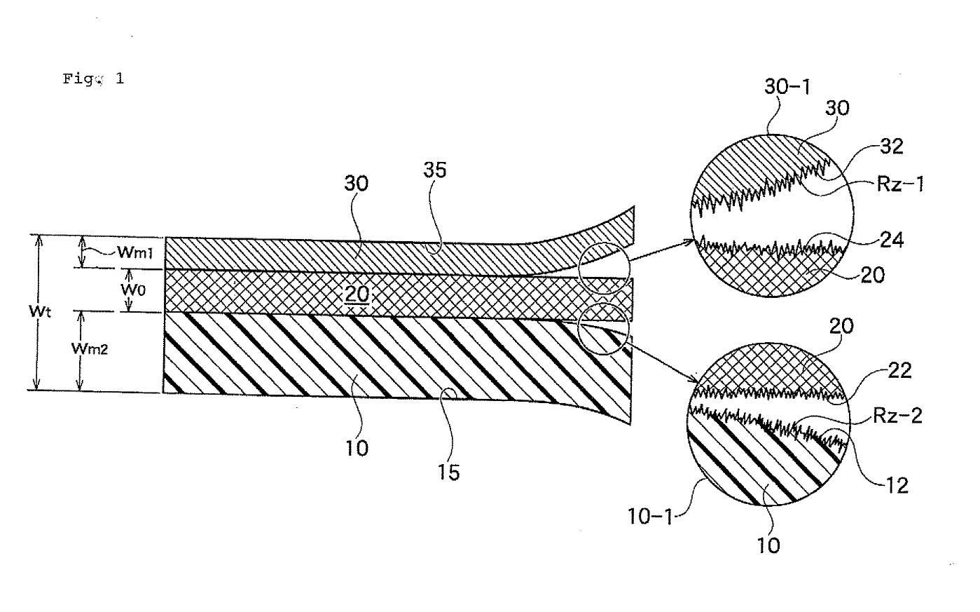

FIG. 1 includes a sectional view schematically showing a section of the metal composite laminate for producing a flexible wiring board of the invention and enlarged sectional views thereof.

In the metal composite laminate for producing a flexible wiring board of the invention, a support metal layer 10 that serves as a support is formed on the back surface of an insulating resin layer 20, and a wiring-forming metal layer 30 for forming a wiring pattern is formed on the front surface of the insulating resin layer 20, as shown in FIG. 1.

As a resin for forming the insulating resin layer 20, a resin having flexibility and insulating properties can be used. Examples of such resins include solvent-soluble linear polymers such as a vinyl acetal resin, a phenoxy resin, a polyamide resin, a polyamide-imide resin, polyether sulfone and a solvent-soluble polyimide resin, an epoxy resin blend comprising an epoxy resin, a curing agent and a curing accelerator, and a urethane resin. Of these, an epoxy resin blend composed of at least one resin (linear polymer) selected from the above solvent-soluble linear polymers, an epoxy resin, a curing agent and a curing accelerator can be used so that two metal foils may be favorably bonded.

Examples of the curing agents used herein include phenol-based epoxy curing agents such as a phenol-novolak resin, and amine-based epoxy resin curing agents such as diaminodiphenyl sulfone. Examples of the curing accelerators include triphenylphosphine, imidazoles, and urea derivatives such as dimethylurea. These can be used singly or in combination of two or more kinds.

The blending ratio by weight between the epoxy resin and the solvent-soluble linear polymer in the epoxy resin blend can be appropriately determined. In the present invention, the insulating resin layer 20 is preferably flame-retardant, and it is desirable to add a flame retardant such as a bromine-based flame retardant or a phosphorus-based flame retardant, to the above resin blend. The amount of the flame retardant added is as follows. In the case of the bromine-based flame retardant, the amount thereof is in the range of usually 10 to 20 parts by weight, preferably 12 to 18 parts by weight, in terms of bromine, based on 100 parts by weight of the resin component. In the case of the phosphorus-based flame retardant, the amount thereof is in the range of usually 0.5 to 3 parts by weight, preferably 1 to 2 parts by weight, in terms of phosphorus, based on 100 parts by weight of the resin component.

In the present invention, the insulating resin layer 20 is usually a single layer, but it may be a laminate of plural resins.

On the back surface of the insulating resin layer 20, a support metal layer 10 that serves as a support of the metal composite laminate for producing a flexible wiring board is arranged, and on the front surface, a wiring-forming metal layer 30 for forming a wiring pattern is arranged. These wiring-forming metal layer 30 and support metal layer 10 are each usually formed by use of a metal foil, and the insulating resin layer 20 can be formed by applying a coating solution containing an insulating resin to a surface of a metal foil for forming any one of the wiring-forming metal layer 30 and the support metal layer 10, then arranging the other metal layer on a coating layer of the insulating resin in a semi-cured state, and applying a pressure to them under heating.

When the insulating resin layer 20 is formed in the above manner, the surface profile of the surface 12 of the support metal layer 10 is transferred to the back surface 22 of the insulating resin layer 20 at the interface between the support metal layer 10 that serves as a support and the insulating resin layer 20, whereby the formed interface of the insulating resin layer 20 with the support metal layer 10 has the same profile as that of the surface 12 of the support metal layer 10, as indicated by numeral 10-1 in FIG. 1. Likewise, to the surface 24 of the insulating resin layer 20, the surface profile of the surface 32 of the wiring-forming metal layer 30 is transferred, as indicated by numeral 30-1 in FIG. 1.

By being interposed between the support metal layer 10 and the wiring-forming metal layer 30, the insulating resin layer 20 has surface profiles on the front and the back surfaces thereof that are transferred from the surface profiles of the metal layers.

In the present invention, the mean surface roughness (Rz-2) of the support metal layer 10 is in the range of usually 0.5 to 10 μm, preferably 0.5 to 3.0 μm, as indicated by numeral 10-1 in FIG. 1, and the mean surface roughness (Rz-1) of the wiring-forming metal layer 30 is in the range of usually 0.1 to 10 μm, preferably 0.5 to 6.0 μm, as indicated by numeral 30-1 in FIG. 1. The back surface 22 of the insulating resin layer 20 has a surface profile corresponding to the mean surface roughness (Rz-2) of the support metal layer 10, and the front surface of the insulating resin layer 20 has a surface profile corresponding to the mean surface roughness (Rz-1) of the wiring-forming metal layer 30.

In order to allow the insulating resin layer 20 to have the same surface profiles as those of the metal layers interposing the insulating resin layer, it is preferable to use a resin blend consisting of the solvent-soluble linear polymer, the epoxy resin, the curing agent and the curing accelerator that are previously illustrated. In the case where such a resin blend is used as the insulating resin, the insulating resin desirably has high surface profile transfer properties, so that a solvent is added to the coating solution of the resin blend to adjust the viscosity of the solution to an appropriate one. Since the coating layer of the insulating resin in a semi-cured state is interposed between the metal foils and then a pressure is applied to them under heating to form a laminate, the resin layer is desired to have flexibility of a certain level so that the metal layers will be thrust into the resin layer in a semi-cured state to allow the surface profiles of the metal layers transferred to the resin layer. Such a resin blend as above is applied to a surface of a metal foil, then the solvent is removed to semi-cure the resin blend, thereafter a different metal foil is contacted with a surface of the semi-cured insulating resin layer, and a pressure is applied to them under heating, whereby the surface profile of the metal thus contacted is transferred to the semi-cured insulating resin layer. Thus, a metal composite laminate wherein the support metal layer 10 that is a support, the insulating resin layer 20 and the wiring-forming metal layer 30 for forming a wiring pattern have been laminated in this order is obtained. Particularly in the invention, by use of such a resin blend as above, a resist flow, as measured in accordance with MIL-P-13949G, of 5 to 50%, preferably about 10 to 40%, is obtained, and the resin can be prevented from jutting out from the side edge of the laminate when a pressure is applied under heating to bond the metal foils to the resin layer.

A method comprising applying a coating solution of the above components to the surface of one metal foil, semi-curing it and pressure bonding the other metal thereto under heating is described hereinabove. Other methods for forming the insulating resin layer 20 include a method comprising applying the coating solution to a surface of a releasable base material, semi-curing it, then transferring the insulating resin layer to a surface of a metal foil from the releasable base material, arranging metal foils on both surfaces of the thus-transferred semi-cured insulating resin layer and pressure bonding them under heating, and a method comprising forming insulating resin layers on surfaces of metal foils, arranging the metal foils so that the insulating resin layers may face each other and pressure bonding them under heating.

The thickness (W₀) of the insulating resin layer 20 formed as above is in the range of preferably 10 to 30 μm. Further, the thickness of the insulating resin layer 20 is determined so that the total [(Rz-1)+(Rz-2)] of the mean surface roughness (Rz-1) of the surface 32 of the wiring-forming metal layer 30 to be laminated, said surface 32 facing the insulating resin layer 20, and the mean surface roughness (Rz-2) of the surface 12 of the support metal layer 10, said surface 12 facing the insulating resin layer 20, will be in the range of 3 to 60%, preferably 2 to 50%, of the thickness (W₀) of the insulating resin layer 20.

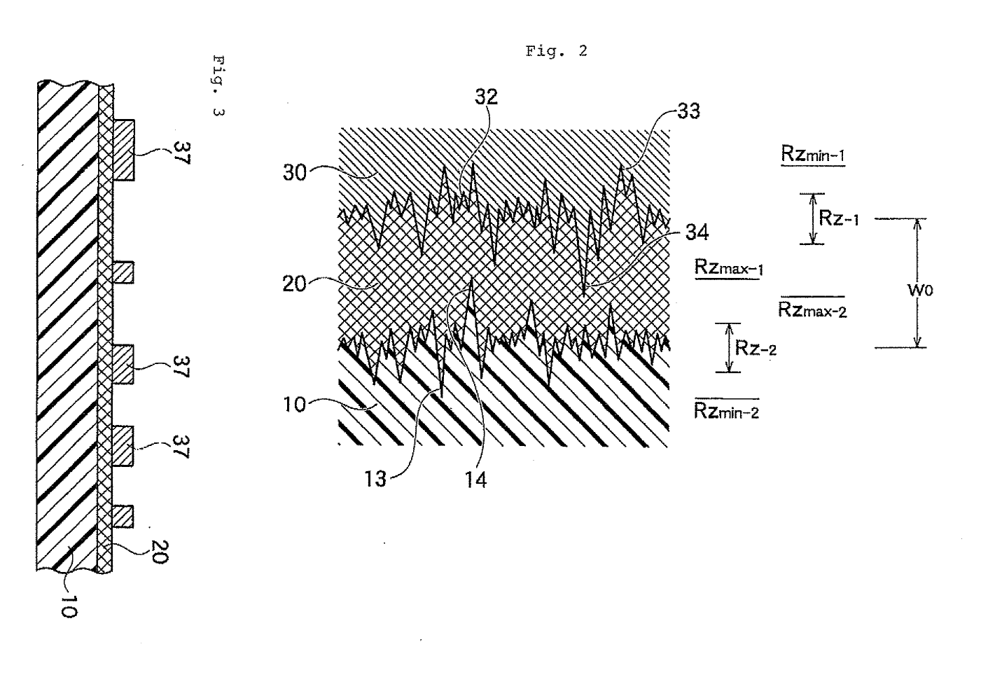

That is to say, on the surfaces of the wiring-forming metal layer 30 and the support metal layer 10 which are to be laminated on the front and the back surfaces of the insulating resin layer 20, a large number of recesses and protrusions are generally formed, as shown in FIG. 2. The mean surface roughness (Rz-1) of the wiring-forming metal layer 30 for forming a wiring pattern is in the range of 0.5 to 6.0 μm, and the mean surface roughness (Rz-2) of the support metal layer 10 for forming a support is in the range of 0.5 to 3.0 μm. In the present invention, the mean surface roughness of a metal layer is a mean of values examined at arbitrary 10 points on the surface of the metal layer. As shown in FIG. 2, with regard to the wiring-forming metal layer 30, the margin of the mean surface roughness allowable in the invention is in the range indicated by Rz-1 in FIG. 2. Likewise, with regard to the support metal layer 10, the margin of the mean surface roughness allowable in the invention is in the range indicated by Rz-2 in FIG. 2. With regard to the wiring-forming metal layer 30, although the mean surface roughness (Rz-1) is in the range of the margin indicated by Rz-1, there is a highly protruded portion 34 greatly deviated from the margin of the mean surface roughness (Rz-1) on the surface of the wiring-forming metal layer 30, and this protruded portion 34 is Rzₘₐₓ-1 of the wiring-forming metal layer 30. In contrast with this, the deeply recessed portion 33 greatly deviated from the margin of the mean surface roughness (Rz-1) is Rzₘᵢₙ-1 of the wiring-forming metal layer 30.

Likewise, with regard to the support metal layer 10, although the mean surface roughness (Rz-2) is in the range of the margin indicated by Rz-2, there is a highly protruded portion 14 greatly deviated from the margin of the mean surface roughness (Rz-2) on the surface of the support metal layer 10, and this protruded portion 14 is Rzₘₐₓ-2 of the support metal layer 10. In contrast with this, the deeply recessed portion 13 greatly deviated from the margin of the mean surface roughness (Rz-2) is Rzₘᵢₙ-2 of the wiring-forming metal layer 10.

Therefore, if the protruded portion 34 that is Rzₘₐₓ-1 of the wiring-forming metal layer 30 and the protruded portion 14 that is Rzₘₐₓ-2 of the support metal layer 10 are present at the same position, the total of the protruded portion 34 and the protruded portion 14 exceeds the mean thickness W₀ of the insulating resin layer 20, and as a result, short circuit occurs between the protruded portion 34 and the protruded portion 14. On the other hand, short circuit does not occur between the protruded portion 14 and the recessed portion 34.

If the thickness of the insulating resin layer 20 is increased, such a problem does not take place. However, when the insulating resin layer is thickened, rigidity of the metal composite laminate for producing a flexible wiring board is high, and flexibility is liable to be impaired. On this account, there is restriction on the thickness of the insulating resin layer 20, considering flexibility and insulating properties. As a result of various studies of surface profiles of metal foils, the mean surface roughness (Rz-1, Rz-2) of the metal layers 10, 30 and the mean thickness (W₀) of the insulating resin layer 20 are made to be in the specific ranges, and thereby, ranges in which short circuit due to such close contact of the protruded portion of the wiring-forming metal layer with the protruded portion of the base metal layer as above does not occur between the wiring-forming metal layer and the base metal layer are determined in the invention.

In the metal composite laminate for producing a flexible wiring board of the invention, the maximum value (Rzₘₐₓ-1) of the surface roughness of the surface of the wiring-forming metal layer 30 is in the range of 1 to 55% of the thickness (W₀) of the insulating resin layer 10, and the maximum value (Rzₘₐₓ-2) of the surface roughness of the surface of the support metal layer 10 is in the range of 1 to 55% of the thickness (W₀) of the insulating resin layer 10. By determining the mean thickness (W₀) of the insulating resin layer 10 to the maximum values of the surface roughness of the metal layers in the above range, short circuit does not occur in the insulating resin layer.

Although the surface profile of the wiring-forming metal layer 30 and the surface profile of the support metal layer 10 can be roughly grasped by measuring the mean surface roughness (Rz-1) and the mean surface roughness (Rz-2) of the metal layers, as described above, the values obtained by this measurement show rough images of the metal foils, and in the actual process for producing a wiring board, it is impossible to inspect the whole surfaces of the metal foils for forming the metal layers to grasp all the protrusions present on the surfaces.

According to the present invention, however, by measuring the mean surface roughness (Rz-1) of the wiring-forming metal layer 30, the mean surface roughness (Rz-2) of the support metal layer 10 and the mean thickness (W₀) of the insulating resin layer 10, which are measurable, the insulating resin layer 20 is formed to have such a mean thickness (W₀) that the total [(Rz-1)+(Rz-2)] of the mean surface roughness (Rz-1) and the mean surface roughness (Rz-2) is in the range of 3 to 60%, preferably 2 to 50%, of the mean thickness (W₀) of the insulating resin layer 20, whereby short circuit between the wiring-forming metal layer 30 and the support metal layer 10 can be prevented nearly perfectly. Further, when a wiring board is formed by use of the insulating resin layer 29, the wiring board has extremely good flexibility, and even if it is used while being bent, peeling or disconnection of a wiring pattern does not take place.

Moreover, the support metal layer 10 is a metal layer that serves as a support, while the wiring-forming metal layer 30 is a metal layer for forming a wiring pattern, so that in the final form, the whole surface of the support metal layer is bonded to the surface of the insulating resin layer 20. From the viewpoint of such a final use form of the wiring-forming metal layer 30 and the support metal layer, it is necessary to further enhance adhesive strength of the fine wiring pattern 37 to the insulating resin layer 20. On the other hand, the support metal layer 10 that is a support is bonded all over the surface to the insulating resin layer 20, and therefore, even if the adhesive strength of the support metal layer 10 to the insulating resin layer 20 is lower than that of the wiring-forming metal layer 30, the support metal layer 10 sufficiently functions as a support.

In the present invention, the ratio [(Rz-2):(Rz-1)] between the mean surface roughness (Rz-2) of the support metal layer and the mean surface roughness (Rz-1) of the wiring-forming metal layer is made to be in the range of 4:1 to 1:12, preferably 1:1 to 1:10, particularly preferably 0.8:1 to 1:6, whereby the adhesive strength of a wiring pattern 37 in the resulting wiring board and the adhesive strength of the support metal layer 19 are adjusted.

In the present invention, by regulating the total [(Rz-1)+(Rz-2)] of the mean surface roughness (Rz-1) of the wiring-forming metal layer 30 and the mean surface roughness (Rz-2) of the support metal layer 10, and the mean thickness (W₀) of the insulating resin layer 10, prevention of short circuit and securing of flexibility are achieved. By increasing the proportion of the mean surface roughness (Rz-1) of the wiring-forming metal layer 30 requiring higher adhesive strength to the insulating resin layer 20 in the total [(Rz-1)+(Rz-2)] of the mean surface roughness, very excellent adhesion of the wiring pattern formed is obtained, and even if the proportion of the mean surface roughness (Rz-1) of the support metal layer 10 bonded all over the surface to the insulating resin layer 10 is low, the support metal layer 10 that is a support in a flexible wiring board obtained from the metal composite laminate of the invention will not be peeled off. In the present invention, by distributing the total [(Rz-1)+(Rz-2)] of the mean surface roughness (Rz-1) of the wiring-forming metal layer 30 and the mean surface roughness (Rz-2) of the support metal layer 10 according to the functions of the wiring-forming metal layer 30 and the support metal layer 10, it is possible to form a wiring board free from occurrence of short circuit and having flexibility and high bending strength.

The technical idea that occurrence of short circuit, flexibility and bending strength of a wiring board are controlled by the mean surface roughness (Rz-1) of the wiring-forming metal layer, the mean surface roughness (Rz-2) of the support metal layer and the mean thickness (W₀) of the insulating resin layer, which are generally measurable, in the production process has been unknown so far.

In such a metal composite laminate for producing a flexible wiring board of the invention, the wiring-forming metal layer 30 laminated on the front surface of the insulating resin layer 20 is a layer to form a wiring pattern for mounting a semiconductor thereon, by etching or the like. Examples of metal foils to form a wiring pattern in the above manner include a copper foil, an aluminum foil, a nickel foil and a stainless steel foil. In the present invention, a copper foil is preferably used from the viewpoints of electrical resistance and ease of processing.

In the case where the wiring-forming metal layer 30 is formed from a copper foil, any of an electrodeposited copper foil and a rolled copper foil is employable. The thickness (Wₘ₁) of such a wiring-forming metal layer 30 is in the range of usually 5 to 35 μm, preferably 8 to 30 μm. By use of a copper foil of such a thickness, a wiring pattern having a thickness of 5 to 35 μm, preferably 5 to 30 μm, can be formed.

In the case where the wiring-forming metal layer 30 is formed from a copper foil, the mean surface roughness (Rz-1) of its side facing the front surface of the insulating resin layer 20 is in the range of 0.5 to 3.0 μm. If the mean surface roughness (Rz-1) is less than 0.5 μm, sufficient adhesive strength to the insulating resin layer 20 is not exhibited, and hence, peeling of the wiring pattern formed takes place. If the mean surface roughness (Rz-1) exceeds 6.0 μm, a possibility of occurrence of short circuit between the wiring-forming metal layer 30 and the support metal layer 10 is increased, and an effective wiring board cannot be stably produced. Particularly in the invention, by setting the mean surface roughness (Rz-1) of the wiring-forming metal layer 30 to a preferred value in the above range, peeling of the wiring pattern formed will not be peeled, and besides, short circuit will not occur between the wiring-forming metal layer 30 and the support metal layer 10.

The side 32 of the copper foil for constituting the wiring-forming metal layer 30, said side facing the insulating resin layer 20, may have been surface-treated with a metal such as Ni, Cr, Zn, Sn or Co. These metals may be used singly or in combination. This side may have been subjected to other surface treatments, such as nodulizing treatment and silane coupling treatment, if necessary.

In the case where a rolled copper foil is used for the wiring-forming metal layer 30, there is generally no difference in surface roughness between the front and the back sides of the rolled copper foil, and hence, when the mean surface roughness (Rz-1) is adjusted in the above range, any side may be utilized.

In the case where an electrodeposited copper foil is used to form the wiring-forming metal layer 30, however, there are a deposition start side (S side) and a deposition finish side (N side) in the electrodeposited copper foil, and in general, the surface roughness of the S side is lower than that of the M side. In the case where the wiring-forming metal layer 30 is formed by use of the electrodeposited copper foil, it is preferable in the invention to arrange the S side as the side facing the insulating resin layer 30. When the S side of the wiring-forming metal layer 30 is bonded to the insulating resin layer with an adhesive, the mean surface roughness (Rz-1) of the S side is adjusted in the above range in the invention. By use of the aforesaid insulating resin layer, extremely high adhesive strength is exhibited even if the S side having such a mean surface roughness (Rz-1) as above is bonded.

If the M side is used, its mean surface roughness (Rz-1) would rather exceed the upper limit of the above range frequently. In the case of using the M side, therefore, its surface needs to be conditioned by etching or the like.

The mean surface roughness of the back surface 35 of the wiring-forming metal layer 10, said back surface not facing the insulating resin layer 20, is in the range of usually 0.01 to 10 μm, preferably 0.1 to 8 μm, and such a mean surface roughness is nearly equal to the surface roughness of the M side of an electrodeposited copper foil.

In the metal composite laminate for producing a flexible wiring board of the invention, the support metal layer 10 is a metal layer that serves as a support, and examples of metal foils to form such a support metal layer 10 include a copper foil, an aluminum foil, a nickel foil, a stainless steel foil and an invar foil.

That is to say, this support metal layer 10 is a layer that serves as a support of the metal composite laminate, and it may be formed from the same metal as that of the wiring-forming metal layer 30 or may be formed from a different metal. In the case where the wiring-forming metal layer 30 and the support metal layer 10 are formed from the same metal, the coefficient of thermal expansion of the wiring-forming metal layer 30 and that of the support metal layer 10 are the same as each other, and hence, even if heating and cooling of the metal composite laminate of the invention are repeated, occurrence of warpage of a wiring board formed from the metal composite laminate can be prevented. The invar film is almost free from expansion and shrinkage due to heat, so that by use of the invar film, a metal composite laminate for producing a flexible wiring board, which has extremely high dimensional stability, can be formed. If a copper foil is used for the support metal layer 10 and if a copper foil is used to form the wiring-forming metal layer 30, the coefficient of thermal expansion of the wiring-forming metal layer 30 and that of the support metal layer 10 are the same as each other because the same metal foil is used. Therefore, the metal composite laminate of the invention rarely suffers warpage or the like even by change of temperature. The support metal layer can be also formed from an aluminum foil. The aluminum foil can be readily surface-treated by, for example, anodizing.

The support metal layer is a layer that serves as a support in the flexible wiring board of the invention, and this support metal layer is a layer also functioning as a heat dissipation part. In order to further enhance heat dissipation efficiency, the surface area ratio represented by the following formula (1) regarding the back surface 15 of the support metal layer 10, said back surface being not in contact with the insulating resin layer 20, is in the range of preferably 1 to 250,000, particularly preferably 300 to 200,000.

Surface area ratio (actual surface area of metal layer)/(ideal smooth surface area of metal layer) (1)

A support metal layer whose back surface 15 has a surface area ratio of the above value has a large contact area with air, and hence, it shows very excellent heat dissipation properties.

A metal foil having such a surface area ratio as above can be obtained in the following manner. When the metal foil is, for example, an electrodeposited copper foil, the electrodeposited copper foil having the above surface area ratio can be obtained by use of the M side, and if necessary, by surface roughening treatment of the corresponding side. The mean surface roughness of the back surface 15 of this support metal layer is in the range of usually 0.01 to 10 μm, preferably 0.1 to 5 μm. When the metal foil is an aluminum foil, the aluminum foil having such a surface profile as above can be readily formed by anodization.

Particularly in the invention, pretreatment usually comprising polishing an aluminum foil serving as an anode with an emery paper, buffing it with an aluminum powder and then subjecting it to ultrasonic cleaning is carried out prior to anodizing. The aluminum foil thus subjected to ultrasonic cleaning is further subjected to electrolytic polishing by use of an electrolytic polishing solution for aluminum, such as phosphoric acid, sulfuric acid or chromic acid, under application of a voltage of 10 to 90 V.

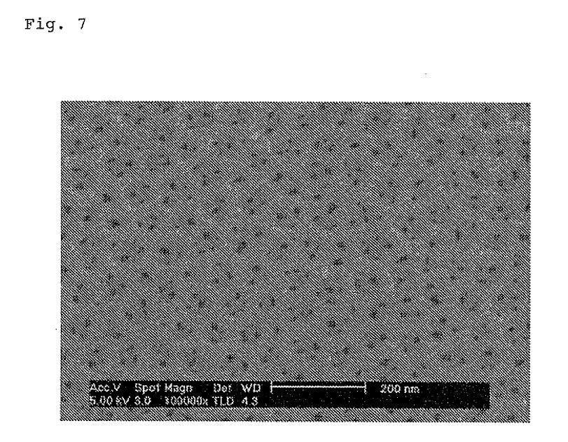

The aluminum foil thus subjected to electrolytic polishing is then anodized in sulfuric acid having a concentration of about 10 to 20% using the aluminum foil as an anode and Pt as a cathode under the conditions of an applied voltage of about 10 to 30 V, an anodizing time of about 0.1 to 5 minutes and a temperature of about 1 to 25° C., whereby an anodized aluminum foil favorably employable as the support metal layer of the invention can be produced. An example of the anodized aluminum foil thus obtained is shown in FIG. 7. FIG. 7 is an electron micrograph of the anodized aluminum foil. The anodized aluminum foil shown in FIG. 7 has a surface profile having holes formed by anodization and holes formed by pitting during anodization. Therefore, the surface area ratio represented by the aforesaid formula (I) is extremely high, and very excellent heat dissipation properties are exhibited.

In the metal composite laminate for producing a flexible wiring board of the invention, the support metal layer 10 is preferably formed from such a metal foil as previously described, and the metal foil is particularly preferably a copper foil, an aluminum foil, an anodized aluminum foil or an invar foil.

The thickness (Wₘ₂) of the support metal layer 10 is in the range of usually 12 to 75 μm. If the thickness of the support metal layer 10 is less than 12 μm, an effect of preventing dimensional change of the wiring board due to moisture absorption of the insulating resin layer 20 or the like is not sufficiently exerted occasionally. If the thickness thereof exceeds 75 μm, it is difficult to use the flexible wiring board of the invention while being bent.

In the metal composite laminate for producing a flexible wiring board of the invention, further, the ratio (Wₘ₁/Wₘ₂) of the thickness (Wₘ₁) of the wiring-forming metal layer 30 to the thickness (Wₘ₂) of the support metal layer 10 is in the range of usually 3/35 to 35/12. By determining the thickness of the wiring-forming metal layer 30 and the thickness of the support metal layer 10 as above, a wiring board having not only excellent flexibility but also excellent bending properties can be formed.

It is necessary that the mean surface roughness (Rz-2) of the surface 12 of the support metal layer, said surface facing the insulating resin layer 20, should be in the range of 0.5 to 3.0 μm and the total [(Rz-1)+(Rz-2)] of the mean surface roughness (Rz-1) of the wiring-forming metal layer and the mean surface roughness (Rz-2) of the support metal layer should be in the range of 3 to 60% of the thickness (W₀) of the insulating resin layer, as described above. This support metal layer 10 is bonded all over the surface as a support to the insulating resin layer 20, so that the support metal layer is more hardly peeled than the wiring-forming metal layer 10 when they are bent. On this account, by setting the ratio [(Rz-2):(Rz-1)] between the mean surface roughness (Rz-2) of the support metal layer and the mean surface roughness (Rz-1) of the wiring-forming metal layer in the range of 4:1 to 1:12, preferably 1:1 to 1:10, particularly preferably 0.8:1 to 1:6, insulating properties and adhesive strength can be balanced. Moreover, even if the insulating resin layer 20 is not thickened excessively, short circuit does not occur, and hence, flexibility of the wiring board is not impaired.

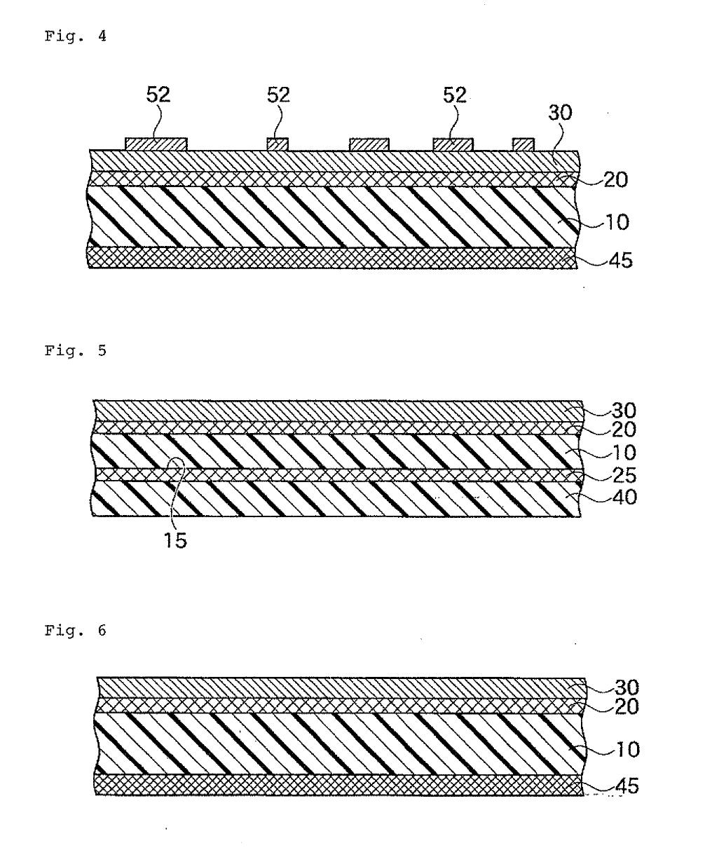

It is enough that the metal composite laminate for producing a flexible wiring board of the invention has the wiring-forming metal layer 30 for forming a wiring pattern on one surface of the insulating resin layer 20 and has the support metal layer 10 serving as a support on the other surface. However, a support resin layer 45 can be formed on the surface of the support metal layer 10, as shown in FIG. 6, in order that when a wiring pattern 37 is formed by forming a photosensitive resin layer on the surface of the wiring-forming metal layer 30, exposing/developing the photosensitive resin layer to form a desired pattern 52 and selectively etching the wiring-forming metal layer 30 using the pattern 52 as a masking material, as shown in FIG. 4, the support metal layer 10 arranged on the other surface of the insulating resin layer 20 to form a support may be prevented from being dissolved by contact with the etching solution, and in order to reinforce the metal composite laminate for producing a flexible wiring board of the invention. It is preferable to handle the metal composite laminate for producing a flexible wiring board of the invention in which such a support resin layer 45 has been arranged.

The support resin layer 45 can be formed by applying a resin having good chemical resistance or can be formed by bonding a separately prepared film. If the support resin layer 45 is arranged for the purpose of protecting the support metal layer 10 in the etching process, the support resin layer 45 does not need to be thickened so much, and the thickness thereof is in the range of usually 1 to 100 μm. If the support resin layer 45 is left as a support after etching, the thickness thereof is in the range of usually 2 to 50000 μm, preferably about 2 to 10000 μm.

It is enough that the metal composite laminate for producing a flexible wiring board of the invention has the wiring-forming metal layer 30 for forming a wiring pattern on one surface of the insulating resin layer 20 and has the support metal layer 10 serving as a support on the other surface. In the case where the support metal layer 10 serving as a support is intended to be further thickened, however, it is possible that an insulating adhesive resin layer 25 serving as an adhesive layer is provided on the back surface 15 of the support metal layer 10 and a sub-support metal layer 40 is further arranged using the insulating adhesive resin layer 25 as an adhesive layer, as shown in FIG. 5. For the insulating adhesive resin layer 25, although a resin having insulating properties and adhesion properties can be used, the same resin as used for forming the insulating resin layer 20 of the metal composite laminate of the invention, for example, is also employable. The thickness of the insulating adhesive resin layer 25 is in the range of usually 0.5 to 100 μm, preferably 3 to 80 μm. The thickness of the sub-support metal layer 40 is in the range of usually 1 to 75 μm, preferably 1 to 35 μm.

The insulating adhesive resin layer 25 and the sub-support metal layer 40 can be further laminated in the same manner as above.

The flexible wiring board of the invention formed from such a metal composite laminate as above is a flexible wiring board wherein the wiring-forming metal layer of the metal composite laminate having the wiring-forming metal layer 30 laminated on the front surface of the insulating resin layer 20 having a flexibility and the support metal layer 10 laminated on the back surface has been etched into a desired pattern, as shown in FIG. 3.

The total thickness (Wₜ) of the metal composite laminate used for producing the flexible wiring board of the invention is in the range of 35 to 130 μm, and the thickness (W₀) of the insulating resin layer 20 is in the range of 10 to 30 μm.

Further, the mean surface roughness (Rz-1) of a side of the wiring pattern 37 present on the front surface of the insulating resin layer 20, said side of the wiring pattern being in contact with the insulating resin layer 20, is in the range of 0.5 to 6.0 μm. The mean surface roughness (Rz-2) of a side of the support metal layer 10 facing the back surface of the insulating resin layer 20, said side of the support metal layer being in contact with the insulating resin layer 20, is in the range of 0.5 to 3.0 μm.

The total [(Rz-1)+(Rz-2)] of the mean surface roughness (Rz-1) of the wiring pattern 37 and the mean surface roughness (Rz-2) of the support metal layer 10 is in the range of 3 to 60% of the thickness (W₀) of the insulating resin layer 20, and the ratio [(Rz-2):(Rz-1)] between the mean surface roughness (Rz-2) of the support metal layer 10 and the mean surface roughness (Rz-1) of the wiring pattern 37 is in the range of 0.8:1 to 1:12, preferably 4:1 to 1:10.

In the flexible wiring board of the invention, the surface area ratio represented by the following formula (1) regarding a side of the support metal layer 10, said side not facing the insulating resin layer 20, is in the range of 1 to 250,000, preferably 300 to 200,000.

Surface area ratio=(actual surface area of metal layer)/(ideal smooth surface area of metal layer) (1)

In such a flexible wiring board of the invention, the wiring pattern can be formed by etching of the wiring-forming metal layer composed of at least one metal foil selected from the group consisting of a copper foil, an aluminum foil, a nickel foil and a stainless steel foil, as previously described.

The support metal layer is preferably formed from at least one metal foil selected from the group consisting of a copper foil, an aluminum foil, a nickel foil, a stainless steel foil and an invar foil. The support metal layer is particularly preferably formed from an electrodeposited copper foil, an aluminum foil, an anodized aluminum foil or an invar foil.

The insulating resin layer is preferably a layer formed by applying an adhesive resin composition containing any one resin selected from the group consisting of at least one solvent-soluble washing polymer that is selected from the group consisting of a polyvinyl acetal resin, a phenoxy resin, a polyamide-imide resin, polyether sulfone and a solvent-soluble polyimide resin, an epoxy resin blend comprising an epoxy resin precursor, a cured material and a curing accelerator, and a urethane resin, as previously described.

On the side of the metal support layer 10 of the metal composite laminate, said side not facing the insulating resin layer 20, a support resin layer 45 can be arranged. It is preferable to handle the wiring board of the invention in which such a support resin layer 45 has been arranged.

The flexible wiring board of the invention can be produced by continuously forming a large number of wiring boards on the surface of the metal composite laminate during the time between winding-off of the metal composite laminate in the form of a tape having been wound round a raw sheet-winding reel and winding-up of the tape of the metal composite laminate round a wind-up reel.

### EXAMPLES

The present invention is further described with reference to the following examples, but it should be construed that the invention is in no way limited to those examples.

### Example 1

To the M side (Rz: 5.5 μn) of an electrodeposited copper foil (3EC-III foil, thickness: 35 μm) of 35 μm thickness for forming a support metal layer, an epoxy resin composition for forming a support resin layer was applied in such a manner that the dry thickness might be 35 μm. Then, to the S side (Rz: 1.1 μm) of the electrodeposited copper foil, an epoxy resin composition for forming an insulating resin layer was applied in such a manner that the dry thickness might be 12 μm. In the three-layer laminate (base tape) thus formed, sprocket holes for base tape transportation, device holes for IC bonding and bending portion holes for use of a wiring board while being bent were formed. Subsequently, the S side (Rz: 1.2 μm) of an electrodeposited copper foil (FQ-VLP foil, thickness: 25 μm) for forming a wiring-forming metal layer was arranged on the epoxy resin composition coating layer (12 μm) of the three-layer laminate, and they were bonded by roll lamination under the conditions of a temperature of 140° C. and a pressure of 0.3 MPa to produce a metal composite laminate (thickness: 107 μm) for producing a flexible wiring board of the invention.

Then, a photoresist was applied to the surface of the wiring-forming metal layer of the metal composite laminate for producing a flexible wiring board, and the photoresist was dried, exposed and developed to form a pattern. Using the pattern as a masking material, the wiring-forming metal layer was etched, and thereafter, the photoresist was peeled to form a wiring pattern. Onto the wiring pattern thus formed, a solder resist was applied in such a manner that the terminal portion was exposed, then the solder resist was cured, and tin plating was carried out on the exposed terminal portion to form a wiring board.

The moisture absorption expansion coefficient of the base tape of the sample thus obtained was 0 ppm %/RH, and the cumulative dimensional dispersion of the outer lead portion was in the range of ±0.01%.

In this connection, the moisture absorption expansion coefficient of a polyimide film that is a base film for a base tape of a conventional COF (chip on film) constituted of an electrodeposited copper foil and a polyimide film and for a conventional TAB tape constituted of an electrodeposited copper foil, an adhesive and the polyimide film is in the range of about 9 to 15 ppm/% RH, and the cumulative dimensional dispersion of the outer lead portion thereof is usually about ±0.05%.

It was confirmed that the wiring pattern formed as above was free from occurrence of short circuit, and the wiring pattern and the support metal layer were electrically insulated from each other by the epoxy resin layer which was a support resin layer.

### Example 2

To the M side (Rz: 1.1 μm) of an electrodeposited copper foil (DFF foil, thickness: 18 μm) of 18 μm thickness for forming a support metal layer, an epoxy resin composition for forming a support resin layer was applied in such a manner that the dry thickness might be 20 μm. Then, to the S side (Rz: 0.5 μm) of the electrodeposited copper foil, a polyamide-imide resin (PAI resin) for forming an insulating resin layer was applied in such a manner that the dry thickness might be 20 μm.

In the three-layer laminate (base tape) thus formed, sprocket holes for base tape transportation, device holes for IC bonding and bending portion holes for use of a wiring board while being bent were formed.

Subsequently, the M side (Rz: 5.8 μm) of an electrodeposited copper foil (3EC-III foil, thickness: 35 μm) for forming a wiring-forming metal layer was arranged on the PAI resin coating layer (20 μm) of the three-layer laminate, and they were bonded by roll lamination under the conditions of a temperature of 200° C. and a pressure of 0.9 MPa to produce a metal composite laminate (thickness: 93 μm) for producing a flexible wiring board of the invention.

Then, using the metal composite laminate for producing a flexible wiring board, a wiring board was prepared in the same manner as in Example 1.

It was confirmed that the wiring pattern formed as above was free from occurrence of short circuit, and the wiring pattern and the support metal layer were electrically insulated from each other by the epoxy resin layer which was a support resin layer.

### Example 3

To the M side (Rz: 3.3 μm) of an electrodeposited copper foil (3EC-VLP foil, thickness: 18 μm) of 18 μm thickness for forming a support metal layer, a coverlay (an adhesive film comprising polyimide, PI thickness: 25 μm, adhesive thickness: 18 μm) of 43 μm thickness for forming a support resin layer was bonded.

Then, to the S side (Rz: 1.1 μm) of the electrodeposited copper foil, an epoxy resin composition for forming an insulating resin layer was applied in such a manner that the dry thickness might be 12 μm.

In the three-layer laminate (base tape) thus formed, sprocket holes for base tape transportation, device holes for IC bonding and bending portion holes for use of a wiring board while being bent were formed.

Subsequently, the M side (Rz: 5.8 μm) of an electrodeposited copper foil (FQ-VLP foil, thickness: 25 pn) for forming a wiring-forming metal layer was arranged on the epoxy resin composition coating layer (12 μm) of the three-layer laminate, and they were bonded by roll lamination under the conditions of a temperature of 140° C. and a pressure of 0.3 MPa to produce a metal composite laminate (thickness: 98 μm) for producing a flexible wiring board of the invention.

Then, using the metal composite laminate for producing a flexible wiring board, a wiring board was prepared in the same manner as in Example 1.

### Comparative Example 1

To the M side (Rz: 1.1 μm) of an electrodeposited copper foil (DFF foil) of 18 μm thickness for forming a support metal layer, an epoxy resin composition for forming a support resin layer was applied in such a manner that the dry thickness might be 20 μm. Then, to the S side (Rz: 0.5 μm) of the electrodeposited copper foil, a polyamide-imide resin (PAI resin) for forming an insulating resin layer was applied in such a manner that the dry thickness might be 20 μm.

In the three-layer laminate (base tape) thus formed, sprocket holes for base tape transportation, device holes for IC bonding and bending portion holes for use of a wiring board while being bent were formed.

Subsequently, the M side (Rz: 6.7 μm) of an electrodeposited copper foil (3EC-ITI foil, thickness: 35 μm) for forming a wiring-forming metal layer was arranged on the PAI resin coating layer (20 μm) of the three-layer laminate, and they were bonded by roll lamination under the conditions of a temperature of 200° C. and a pressure of 0.9 MPa to produce a metal composite laminate (thickness: 93 μm) for producing a flexible wiring board of the invention.

Then, using the metal composite laminate for producing a flexible wiring board, a wiring board was prepared in the same manner as in Example 1.

The wiring pattern formed as above suffered occurrence of short circuit, and the support metal layer and the wiring-forming metal layer could not be completely insulated from each other by the insulating resin layer present between the support metal layer and the wiring-forming metal layer.

### Comparative Example 2

To the M side (Rz: 5.5 μm) of an electrodeposited copper foil of 35 μm thickness for forming a support metal layer, an epoxy resin composition for forming a support resin layer was applied in such a manner that the dry thickness might be 35 μm.

Then, to the S side (Rz: 2.2) of the electrodeposited copper foil, an epoxy resin for forming an insulating resin layer was applied in such a manner that the dry thickness might be 7 μm.

In the three-layer laminate (base tape) thus formed, sprocket holes for base tape transportation, device holes for IC bonding and bending portion holes for use of a wiring board while being bent were formed.

Subsequently, the S side (Rz: 2.4 μm) of an electrodeposited copper foil (FQ-VLP foil, thickness: 25 μm) for forming a wiring-forming metal layer was arranged on the epoxy resin layer (7 μm) of the three-layer laminate, and they were bonded by roll lamination under the conditions of a temperature of 140° C. and a pressure of 0.3 MPa to produce a metal composite laminate (thickness: 102 μm) for producing a flexible wiring board of the invention.

Then, using the metal composite laminate for producing a flexible wiring board, a wiring board was prepared in the same manner as in Example 1.

The wiring pattern formed as above suffered occurrence of short circuit, and the support metal layer and the wiring-forming metal layer could not be completely insulated from each other by the insulating resin layer present between the support metal layer and the wiring-forming metal layer.

### Comparative Example 3

To the M side (Rz: 1.1 μm) of an electrodeposited copper foil (DFF foil) of 18 μm thickness for forming a support metal layer, an epoxy resin composition for forming a support resin layer was applied in such a manner that the dry thickness might be 20 μm. Then, to the S side (Rz: 2.2 μm) of the electrodeposited copper foil, a polyamide-imide resin (PAI resin) for forming an insulating resin layer was applied in such a manner that the dry thickness might be 20 μm.

In the three-layer laminate (base tape) thus formed, sprocket holes for base tape transportation, device holes for IC bonding and bending portion holes for use of a wiring board while being bent were formed.

Subsequently, the M side (Rz: 11.6 μm) of an electrodeposited copper foil (3EC-III foil, thickness: 35 μm) for forming a wiring-forming metal layer was arranged on the PAI resin coating layer (20 μm) of the three-layer laminate, and they were bonded by roll lamination under the conditions of a temperature of 200° C. and a pressure of 0.9 MPa to produce a metal composite laminate (thickness: 93 μm) for producing a flexible wiring board of the invention.

Then, using the metal composite laminate for producing a flexible wiring board, a wiring board was prepared in the same manner as in Example 1.

The wiring pattern formed as above suffered occurrence of short circuit, and the support metal layer and the wiring-forming metal layer could not be completely insulated from each other by the insulating resin layer present between the support metal layer and the wiring-forming metal layer.

The results of the examples and the comparative examples are set forth in Table 1.

TABLE 1

| | Ex. 1 | Ex. 2 | Ex. 3 | Comp. Ex. 1 | Comp. Ex. 2 | Comp. Ex. 3 |
|---|---|---|---|---|---|---|
| Support resin layer | epoxy resin | epoxy resin | PI coverlay | epoxy resin | epoxy resin | epoxy resin |
| | 35 μm | 20 μm | 25 + 18 | 20 μm | 35 μm | 20 μm |
| Rz | M-5.5 μm | M-1.1 μm | M-3.3 μm | M-1.1 μm | M-5.5 μm | M-1.1 μm |
| Support metal layer | 3EC-III | DFF | 3EC-VLP | DFF | 3EC-III | DFF |
| (Wₘ₂) | 35 μm | 18 μm | 18 μm | 18 μm | 35 μm | 18 μm |
| Rz-2 | S-1.1 μm | S-0.5 μm | S-1.1 μm | S-0.5 μm | S-2.2 μm | S-2.2 μm |
| Insulating resin layer | epoxy resin | PAI resin | epoxy resin | PAI resin | epoxy resin | PAI resin |
| (W₀) | 12 μm | 20 μm | 12 μm | 20 μm | 7 μm | 20 μm |
| Rz-1 | S-1.2 μm | M-5.8 μm | M-5.8 μm | M-6.7 μm | S-2.4 μm | M-11.6 μm |
| Wiring-forming metal | FQ-VLP | 3EC-III | FQ-VLP | 3EC-III | FQ-VLP | 3EC-III |
| layer (Wₘ₁) | 25 μm | 35 μm | 25 μm | 35 μm | 25 μm | 35 μm |
| Total thickness | 107 μm | 93 μm | 98 μm | 93 μm | 102 μm | 93 μm |
| [(Rz-1) + (Rz-2)] | 1.3 | 6.3 | 6.9 | 7.3 | 4.6 | 13.8 |
| [(Rz-1) + (Rz-2)]/W₀ × 100 | 10.83% | 31.50% | 57.50% | 36.5% | 65.71% | 69.00% |
| (Rz-2):(Rz-1) | 1.1:1.2 | 0.5:5.8 | 1.1:5.8 | 0.5:6.7 | 2.2:2.4 | 2.2:11.6 |
| Wₘ₁/Wₘ₂ | 25/35 | 35/18 | 25/18 | 35/18 | 25/35 | 35/18 |
| Laminating conditions | 140° C. | 200° C. | 140° C. | 200° C. | 140° C. | 200° C. |
| Pressure | 0.3 MPa | 0.9 MPa | 0.3 MPa | 0.9 MPa | 0.3 MPa | 0.9 MPa |
| Occurrence of wiring | none | none | none | occurred | occurred | occurred |
| short circuit | | | | | | |

Notes:
The 3EC-III foil, the DFF foil, the 3EC-VLP foil the FQ-VLP foil, etc. that are used are all available from Mitsui Mining & Smelting Co., Ltd. As a result of close inspection of the surface profiles of the copper foils used, the Rzₘₐₓ-1 and the Rzₘₐₓ-2 were each in the range of 1 to 55% of the thickness (W₀) of the insulating resin layer.

### INDUSTRIAL APPLICABILITY

The metal composite laminate for producing a flexible wiring board of the invention has a structure wherein a support metal layer, an insulating resin layer and a wiring-forming metal layer are laminated in this order and the total thickness is in the range of 35 to 130 μm. In the metal composite laminate, for example, the surface of the support metal layer having been adjusted to have a mean surface roughness (Rz-2) of 0.5 to 3 μm can be bonded to the insulating resin layer, and the surface (usually S side) of the wiring-forming metal layer having been adjusted to have a mean surface roughness (Rz-1) of 0.5 to 6.0 μm can be bonded to the insulating resin layer. Further, since the total of the mean surface roughness of the support metal layer and the mean surface roughness of the wiring-forming metal layer is in the range of 3 to 60% of the thickness of the insulating resin layer, short circuit does not occur between the support metal layer and the wiring-forming metal layer. Furthermore, the metal composite laminate of the invention is a metal composite laminate wherein the support metal layer, the insulating resin layer and the wiring-forming metal layer are firmly bonded to each other, and has flexibility.

On this account, a wiring board produced by use of the metal composite laminate of the invention is free from peeling of a wiring pattern formed at the bending portion even if the wiring board is used while being bent, and the wiring board has very excellent flexibility. Moreover, the moisture absorption expansion coefficient of the wiring board is substantially zero, and dimensional change due to moisture absorption is extremely small, so that cumulative dimensional dispersion of a lead due to moisture absorption rarely takes place.

In addition, the mean surface roughness of the metal foils bonded to the insulating resin layer is distributed between the support metal layer and the wiring-forming metal layer according to the necessary bonding strength. Therefore, even if the stress is unevenly distributed as in the case where the wiring board is used while being bent, a bonding power corresponding to the stress can be imparted, and peeling of the wiring pattern or peeling of the support metal layer will not take place.

In the wiring board of the invention, the wiring pattern is formed on a metal foil through an extremely thin insulating resin layer, and heat from an IC semiconductor device mounted thereon is rapidly transferred to the metal foil that is a support without being interrupted by the insulating resin layer and then released. On this account, even if a high-performance IC semiconductor device is mounted, heat of the IC semiconductor device can be efficiently released outside. Hence, high-performance IC semiconductor devices can be mounted with high density.

1. A metal composite laminate for producing a flexible wiring board, having a wiring-forming metal layer which is a layer for forming a wiring pattern and is laminated on the front surface of a flexible insulating resin layer and a support metal layer which serves as a support and is laminated on the back surface of the insulating resin layer, wherein:
the total thickness (Wₜ) of the metal composite laminate is in the range of 35 to 130 μm, and the thickness (W₀) of the insulating resin layer is in the range of 10 to 30 μm,
the mean surface roughness (Rz-1) of the wiring-forming metal layer facing the front surface of the insulating resin layer is in the range of 0.5 to 6.0 μm, and the mean surface roughness (Rz-2) of the support metal layer facing the back surface of the insulating resin layer is in the range of 0.5 to 3.0 μm, the total [(Rz-1)+(Rz-2)] of the mean surface roughness (Rz-1) of the wiring-forming metal layer and the mean surface roughness (Rz-2) of the support metal layer is in the range of 3 to 60% of the thickness (W₀) of the insulating resin layer, and
the ratio [(Rz-2):(Rz-1)] of the mean surface roughness (Rz-2) of the support metal layer to the mean surface roughness (Rz-1) of the wiring-forming metal layer is in the range of 4:1 to 1:12.

2. The metal composite laminate for producing a flexible wiring board as claimed in claim 1, wherein the ratio (Wₘ₁/Wₘ₂) of the thickness (Wₘ₁) of the wiring-forming metal layer to the thickness (Wₘ₂) of the support metal layer in the metal composite laminate for producing a flexible wiring board is in the range of 3/35 to 35/12.

3. The metal composite laminate for producing a flexible wiring board as claimed in claim 1, wherein the maximum value (Rzₘₐₓ-1) of the surface roughness of a side of the wiring-forming metal layer, said side facing the front surface of the insulating resin layer, is in the range of 1 to 55% of the thickness (W₀) of the insulating resin layer, and the maximum value (Rzₘₐₓ-2) of the surface roughness of a side of the support metal layer, said side facing the back surface of the insulating resin layer, is in the range of 1 to 55% of the thickness (W₀) of the insulating resin layer.

4. The metal composite laminate for producing a flexible wiring board as claimed in claim 1, wherein the surface area ratio represented by the following formula (1) regarding a side of the support metal layer, said side not facing the insulating resin layer, is in the range of 1 to 1,600,000;
surface area ratio=(actual surface area of metal layer)/(ideal smooth surface area of metal layer) (1).

5. The metal composite laminate for producing a flexible wiring board as claimed in claim 1, wherein the wiring-forming metal layer is formed from one metal foil selected from the group consisting of a copper foil, an aluminum foil, a nickel foil and a stainless steel foil.

6. The metal composite laminate for producing a flexible wiring board as claimed in claim 1, wherein the support metal layer is formed from one metal foil selected from the group consisting of a copper foil, an aluminum foil, a nickel foil, a stainless steel foil and an invar foil.

7. The metal composite laminate for producing a flexible wiring board as claimed in claim 1, wherein the insulating resin layer is formed by applying an adhesive resin composition containing any resin selected from the group consisting of at least one solvent-soluble linear polymer that is selected from the group consisting of a polyvinyl acetal resin, a phenoxy resin, a polyamide-imide resin, a polyether sulfone and a solvent-soluble polyimide resin; an epoxy resin blend comprising an epoxy resin precursor, a curing agent and a curing accelerator; and a urethane resin.

8. The metal composite laminate for producing a flexible wiring board as claimed in claim 1, wherein on the side of the support metal layer of the metal composite laminate, said side not facing the insulating resin layer, a support resin layer is arranged.

9. The metal composite laminate for producing a flexible wiring board as claimed in claim 8, further having a third metal layer on the surface of the support resin layer where the support metal layer is not arranged.

10. A flexible wiring board comprising a metal composite laminate having a wiring-forming metal layer laminated on the front surface of a flexible insulating resin layer and a support metal layer laminated on the back surface of the insulating resin layer, said wiring-forming metal layer having been etched into a desired pattern, wherein:
the total thickness (Wₜ) of the metal composite laminate is in the range of 35 to 130 μm, and the thickness (W₀) of the insulating resin layer is in the range of 10 to 30 μm,
the mean surface roughness (Rz-1) of a side of the wiring pattern present on the front surface of the insulating resin layer, said side of the wiring pattern being in contact with the insulating resin layer, is in the range of 0.5 to 6.0 μm, and the mean surface roughness (Rz-2) of a side of the support metal layer facing the back surface of the insulating resin layer, said side of the support metal layer being in contact with the insulating resin layer, is in the range of 0.5 to 3.0 μm,
the total [(Rz-1)+(Rz-2)] of the mean surface roughness (Rz-1) of the wiring pattern and the mean surface roughness (Rz-2) of the support metal layer is in the range of 3 to 60% of the thickness (W₀) of the insulating resin layer, and the ratio [(Rz-2):(Rz-1)] of the mean surface roughness (Rz-2) of the support metal layer to the mean surface roughness (Rz-1) of the wiring pattern is in the range of 4:1 to 1:12.

11. The flexible wiring board as claimed in claim 10, wherein the ratio (Wₘ₁/Wₘ₂) of the thickness (Wₘ₁) of the wiring pattern to the thickness (Wₘ₂) of the support metal layer in the metal composite laminate is in the range of 3/35 to 35/12.

12. The flexible wiring board as claimed in claim 10, wherein the maximum value (Rzₘₐₓ-1) of the surface roughness of a side of the wiring pattern, said side facing the front surface of the insulating resin layer, is in the range of 1 to 55% of the thickness (W₀) of the insulating resin layer, and the maximum value (Rzₘₐₓ-2) of the surface roughness of a side of the support metal layer said side facing the back surface of the insulating resin layer, is in the range of 1 to 55% of the thickness (W₀) of the insulating resin layer.

13. The flexible wiring board as claimed in claim 10, wherein the surface area ratio represented by the following formula (I) regarding a side of the support metal layer, said side not facing the insulating resin layer, is in the range of 1 to 250,000:
surface area ratio=(actual surface area of metal 20 layer)/(ideal smooth surface area of metal layer) (1).

14. The flexible wiring board as claimed in claim 10, wherein the wiring pattern is formed by etching of the wiring-forming metal layer composed of one metal foil selected from the group consisting of a copper foil, an aluminum foil, a nickel foil and a stainless steel foil.

15. The flexible wiring board as claimed in claim 10, wherein the support metal layer is formed from one metal foil selected from the group consisting of a copper foil, an aluminum foil, a nickel foil, a stainless steel foil and an invar foil.

16. The flexible wiring board as claimed in claim 10, wherein the insulating resin layer is formed by applying an adhesive resin composition containing any resin selected from the group consisting of at least one solvent-soluble linear polymer that is selected from the group consisting of a polyvinyl acetal resin, a phenoxy resin, a polyamide-imide resin, a polyether sulfone and a solvent-soluble polyimide resin; an epoxy resin blend comprising an epoxy resin precursor, a curing agent and a curing accelerator; and a urethane resin.

17. The flexible wiring board as claimed in claim 10, wherein on the side of the support metal layer of the metal composite laminate, said side not facing the insulating resin layer, a support resin layer is arranged.

18. The flexible wiring board as claimed in claim 10, wherein the wiring pattern is formed by forming a protective layer on a metal-exposed surface of the support metal layer of the metal composite laminate and subsequent selective etching of the wiring-forming metal layer.

19. The flexible wiring board as claimed in claim 10, which is formed by continuously forming a large number of wiring boards on the surface of the metal composite laminate during the time between winding-off of the metal composite laminate in the form of a tape having been wound round a raw sheet-winding reel and winding-up of the tape round a wind-up reel.
